(19) United States
(12) Patent Application Publication
(10) Pub. No.: US 2010/0310268 A1
(43) Pub. Date: Dec. 9, 2010

(54) IMAGE FORMING APPARATUS AND IMAGE FORMING METHOD

(75) Inventor: Satoshi Obata, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/786,808

(22) Filed: May 25, 2010

Related U.S. Application Data
(60) Provisional application No. 61/183,697, filed on Jun. 3, 2009.

(51) Int. Cl. G03G 15/00

(52) U.S. Cl. 399/85

(57) ABSTRACT

According to one embodiment, an image forming apparatus includes an information acquisition section configured to acquire the number of pages of sheets to be printed and information indicating whether printing in a color mode is performed or printing in a monocolor mode is performed for each page, a printing order creation section configured to create a plurality of sets of page printing orders, in which printed sheets are outputted in a job reception order, based on the acquired number of pages and the number of sheets which can be simultaneously conveyed, a switching number calculation section configured to calculate the number of times of switching between the color mode and the monocolor mode for each of the plurality of created sets of page printing orders, and a printing order selection section configured to select one set of page printing order having the smallest calculated number of times of switching.

### CROSS-REFERENCE TO RELATED APPLICATIONS

This application is based upon and claims the benefit of U.S. Provisional Application No. 61/183,697 filed on Jun. 3, 2009; the entire contents of which are incorporated herein by reference.

### FIELD

Embodiments described herein relate generally to an image forming apparatus and an image forming method.

### BACKGROUND

Image forming apparatuses capable of printing an image in full color generally have a black mode in which an image is formed using only black in addition to a full color mode in which an image is formed using four colors of yellow, magenta, cyan and black. Both the modes can be selected. In the black mode, the image forming apparatuses generally stop image forming mechanisms of the three colors other than black, and suppress the exhaustion of photoconductive drums and developing units constituting the image forming mechanisms.

When the full color mode and the black mode are mutually changed, operations, such as separation and contact of a photoconductive drum and a transfer belt, and stop and start of a developing unit, are required. Thus, it takes time to switch the mode, and further, the photoconductive drum, the developing unit and the like are exhausted by the switching operation. Accordingly, it is desired that the number of times of switching between the full color mode and the black mode is as small as possible. However, since the switching between the full color mode and the black mode is determined in accordance with the order of images desired to be printed by the user, the image forming apparatus can not control the switching between the modes.

### BRIEF DESCRIPTION OF THE DRAWINGS

FIG. 1 is an exemplary view showing the whole structure of an image forming apparatus.

FIG. 2 is an exemplary view showing an inner structure of the image forming apparatus.

FIG. 3 is an exemplary view showing a schematic procedure of a printing order determination process.

FIG. 4 is an exemplary view showing printing orders which can be adopted for 6-page double-sided printing in an automatic double-sided apparatus capable of simultaneously conveying two sheets.

FIG. 5 is an exemplary view showing a procedure of listing printing orders in which double-sided printing can be performed.

FIG. 6 is an exemplary view showing data (pages) stored in respective queues when the procedure proceeds in accordance with a flow.

### DETAILED DESCRIPTION

In general, according to one embodiment, an image forming apparatus having a double-sided printing function and a function of simultaneously conveying plural sheets includes: an information acquisition section configured to acquire the number of pages of sheets to be printed and information indicating whether printing in a color mode is performed or printing in a monocolor mode is performed for each page, a printing order creation section configured to create plural sets of page printing orders, in which printed sheets are outputted in a job reception order, based on the acquired number of pages and the number of sheets which can be simultaneously conveyed, a switching number calculation section configured to calculate the number of times of switching between the color mode and the monocolor mode for each of the plural created sets of page printing orders, and a printing order selection section configured to select one set of page printing order having the smallest calculated number of times of switching.

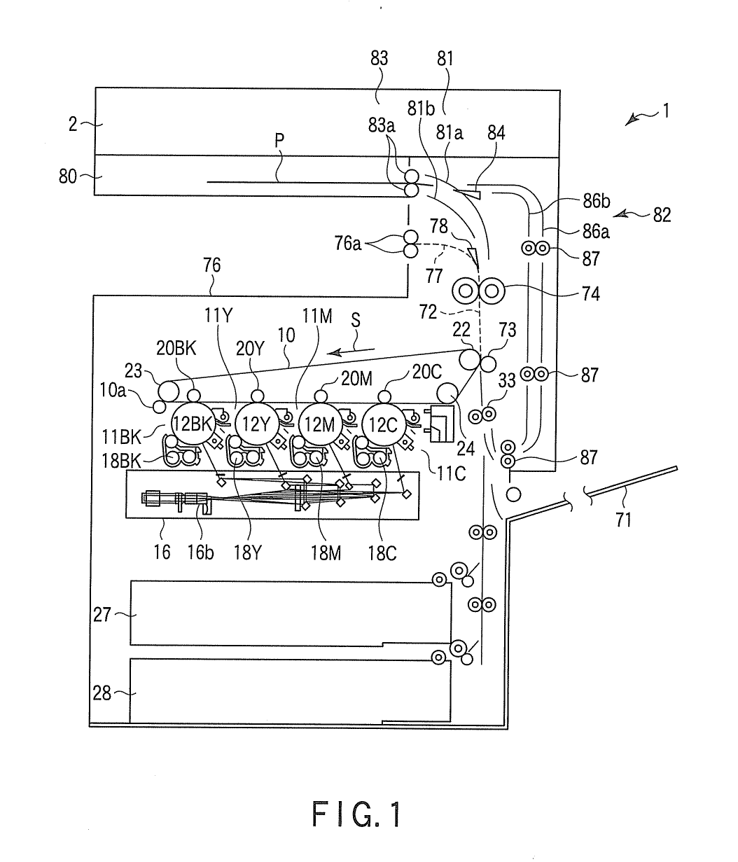

Hereinafter, an image forming apparatus 1 of an embodiment of the present invention will be described with reference to a schematic structural view of FIG. 1. The image forming apparatus 1 is a four-tandem type double-sided image forming apparatus. The image forming apparatus 1 includes a scanner section 2 and a paper discharge section 76 at an upper part, and includes four sets of image forming units 11BK to 11C arranged in parallel along an intermediate transfer belt 10 as an intermediate transfer medium.

The respective image forming units 11BK to 11C respectively include photoconductive drums 12BK to 12C as image carriers and include, around the photoconductive drums and along the rotation direction thereof, charging chargers, exposure sections, developing devices 18BK to 18C, primary transfer rollers 20BK to 20C, and cleaning devices. The exposure sections form latent images on the photoconductive drums 12BK to 12C by laser beams irradiated from a laser exposure device 16 based on image data from the scanner device or the like.

The developing devices 18BK to 18C of the respective image forming units 11BK to 11C respectively perform development using two-component developers including toners and carriers of black (BK), yellow (Y), magenta (M) and cyan (C). The laser exposure device 16 scans a laser beam emitted from a semiconductor laser element in the axial direction of each of the photoconductive drums 12BK to 12C by a polygon mirror, and forms an image on each of the photoconductive drums 12BK to 12C through an imaging lens system 16b and respective mirrors.

The intermediate transfer belt 10 is stretched among a drive roller 22 and driven rollers 23 and 24, are disposed over the respective image forming units 11BK to 11C, and are opposite to and contact the photoconductive drums 12BK to 12C. Primary transfer positions of the intermediate transfer belt 10 are supported by the primary transfer rollers 20BK to 20C. The primary transfer rollers 20BK to 20C apply transfer voltages, and primarily transfer the toner images on the photoconductive drums 12BK to 12C to the intermediate transfer belt. A secondary transfer roller 73 is provided at a secondary transfer position opposite to the drive roller 22. The secondary transfer roller 73 applies a transfer voltage in order to secondarily transfer the toner images primarily transferred on the intermediate transfer belt 10 to a sheet P as a recording medium. A belt cleaner 10a is provided downstream of the secondary transfer roller 73 of the intermediate transfer belt 10.

The image forming apparatus 1 includes the secondary transfer roller 73 and a fixing device 74 along a vertical path 72 to convey the sheet P, which is fed from a paper feed cassette 27 or 28 or a manual feed tray 71, in the vertical direction.

An inversion area 80 as an inversion section is provided above the paper discharge section 76 almost in parallel to the paper discharge section 76. A gate 78 and a paper discharge roller 76a are provided on a paper discharge conveyance path 77 extending from the fixing device 74 to the paper discharge section 76. An inversion conveyance unit 83 extending from the fixing device 74 to the inversion area 80 includes an inversion conveyance path 81 and a switchback roller 83a.

The inversion conveyance path 81 includes inversion guides 81a and 81b and a gate 84. The gate 78 distributes the sheet P to the paper discharge section 76 side or the inversion conveyance path 81 side. The switchback roller 83a is provided at an inlet of the inversion area 80, and rotates in a forward rotation direction to convey the sheet P to the inversion area 80 and in a reverse rotation direction to take out the sheet P from the inversion area 80 to a re-conveying unit 82 side. The gate 84 guides the sheet P from the inversion area 80 to the re-conveying unit 82 side. The re-conveying unit 82 includes re-conveying guides 86a and 86b to guide the sheet P to the secondary transfer roller 73 direction and a re-conveying roller 87.

Next, an image forming operation will be described.

When image information is inputted to the image forming apparatus 1 from the scanner or a terminal of a personal computer, the respective photoconductive drums 12BK to 12C rotate, and the respective image forming units 11BK to 11C successively perform image forming processes. In the black (BK) image forming unit 11BK, the charging charger charges the photoconductive drum 12BK, and an electrostatic latent image is formed by a laser beam corresponding to the image information of black (BK). Further, the developing device 18BK forms a black (BK) toner image on the photoconductive drum 12BK. Next, the photoconductive drum 12BK contacts the intermediate transfer belt 10 rotated in an arrow S direction, and the primary transfer roller 20BK primarily transfers the black (BK) toner image onto the intermediate transfer belt 10.

Similarly to the black (BK) toner image forming process, toner image forming processes of yellow (Y), magenta (M) and cyan (C) are performed. The toner images of yellow (Y), magenta (M) and cyan (C) are successively multiplexly transferred to the same position on the intermediate transfer belt 10 where the black (BK) toner image was formed, and a full color toner image is formed on the intermediate transfer belt 10. Thereafter, the intermediate transfer belt 10 reaches the position of the secondary transfer roller 73, and the overlapped full color toner image of black (BK), cyan (C), magenta (M) and yellow (Y) is secondarily transferred onto the sheet P by the transfer bias of the secondary transfer roller 73.

When an image is formed only on one side of the sheet, the sheet P on which the color image is fixed by the fixing device 74 is distributed to the paper discharge roller 76a side by the gate 78, and is stacked on the paper discharge section 76.

On the other hand, when images are formed on both sides of the sheet, the sheet P on which the color image is fixed by the fixing device 74 is distributed to the inversion conveyance unit 83 side by the gate 78. The sheet P distributed to the inversion conveyance unit 83 side is sent from the leading edge side thereof to the inversion area 80 by the forward rotating switchback roller 83a. When the trailing edge of the sheet P passes through the gate 84, the switchback roller 83a reversely rotates, the sheet P is conveyed from the trailing edge side thereof to the re-conveying unit 82 side, and the front and back sides thereof are inverted. Thereafter, the sheet P is re-conveyed to the position of the secondary transfer roller 73 by the re-conveying unit 82, and a full color toner image is formed on the back side.

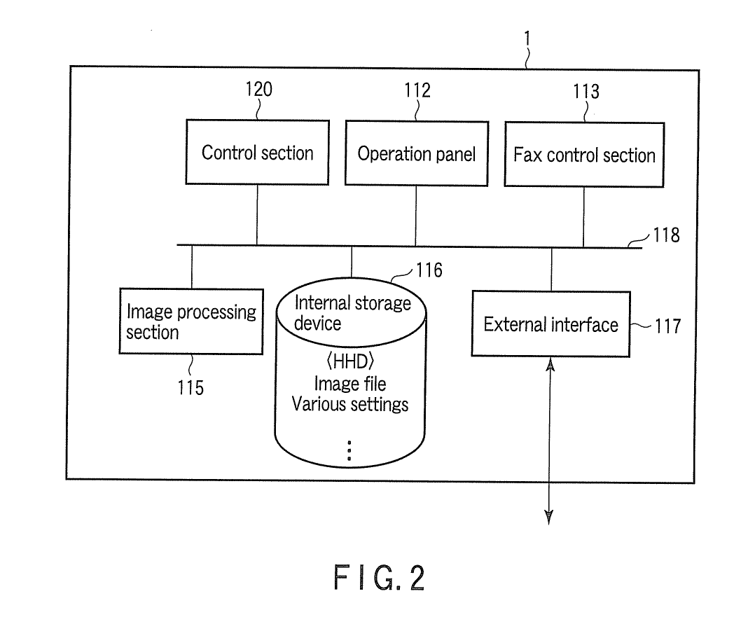

FIG. 2 is a block diagram showing an inner structure of the image forming apparatus 1.

The image forming apparatus 1 includes an operation panel 112, a fax control section 113, an image processing section 115, an internal storage device 116, an external interface 117, a system bus 118 and a control section 120.

The operation panel 112 captures setting of various functions and execution instructions inputted by the user, and displays and notifies necessary information to the user. The fax control section 113 performs facsimile communication with an external device (not shown) through a public switched telephone network PSTN. The image processing section 115 performs an image quality improving process, such as smoothing, on image data captured by the scanner or the like. The internal storage device 116 is a storage medium, such as an HDD, installed in the inside of the image forming apparatus 1. The internal storage device 116 stores an image file, various setting information and the like. The external interface 117 is an interface for giving and receiving various setting information, control information and image data to and from an external device (not shown). The control section 120 controls the respective sections connected through the system bus 118.

Next, a description will be made to a method in which when the image forming apparatus 1 performs double-sided printing, a printing order is determined to suppress exhaustion of the photoconductive drum and the developing unit and to improve printing performance. Incidentally, in the following description, the image forming apparatus 1 performs double-sided printing of six pages. In the six pages, pages 1, 2 and 3 are pages printed in full color, and pages 4, 5 and 6 are pages printed in black. Besides, in the image forming apparatus 1 of this embodiment, at the time of automatic double-sided printing, up to two sheets, one side of each of which is printed, can be held (simultaneously conveyed) in the inside. This function is called two-sheet simultaneous conveyance. Incidentally, the control section 120 determines the printing order.

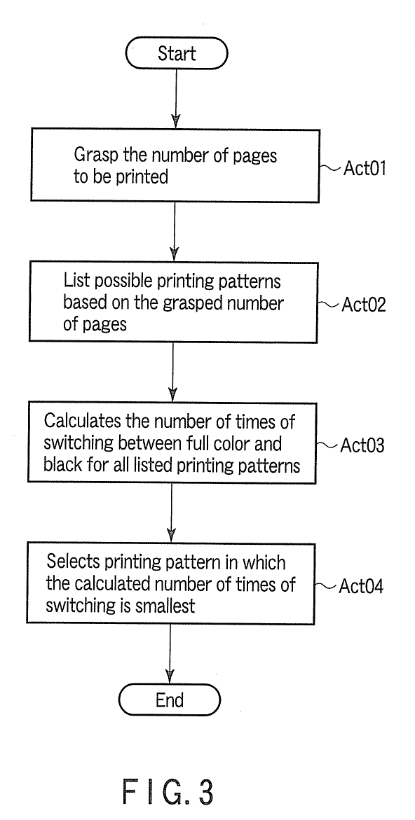

FIG. 3 is a flowchart showing a schematic procedure of a printing order determination process.

When the user sets a document with six pages on an ADF (Automatic Document Feeder) and instructs double-sided printing through the operation panel 112, the scanner 2 reads the document, and stores image data in the internal storage device 116. When the image data of all pages to be printed are stored, at Act 01, the control section 120 recognizes that the double-sided printing of six pages is to be performed.

At Act 02, the control section 120 lists all possible printing orders in the case of the double-sided printing of six pages. In the case of the automatic double-sided apparatus capable of simultaneously conveying two sheets, when expressed in page, the double-sided printing of six pages is expressed in four ways as follows: 2→4→1→6→3→5 (pattern P1), 2→4→1→3→6→5 (pattern P2), 2→1→4→3→6→3→5 (pattern P3) and 2→1→4→3→6→5 (pattern P4).

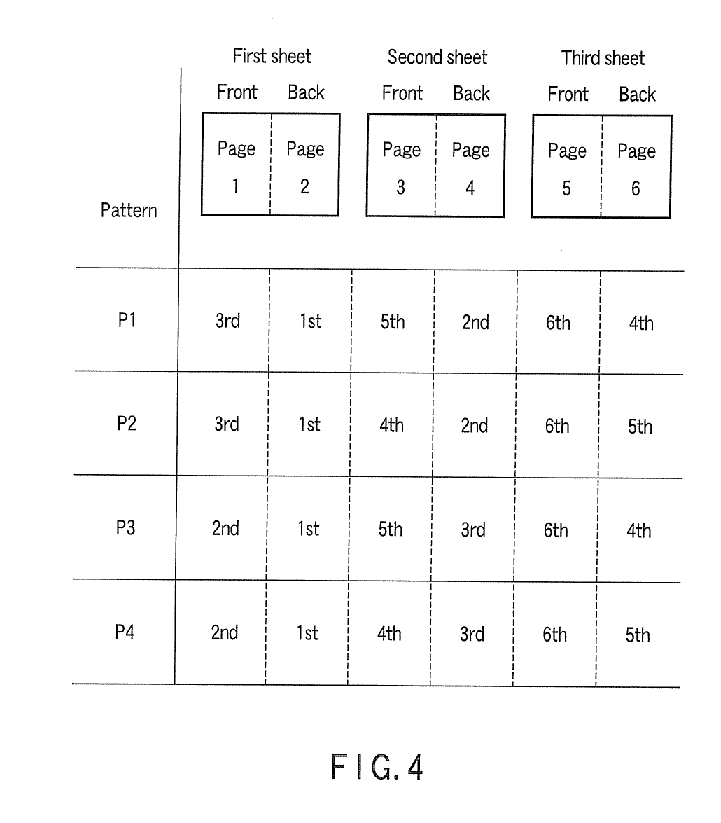

FIG. 4 is a view for explaining the possible printing orders in the case of the double-sided printing of six pages in the automatic double-sided apparatus capable of simultaneously conveying two sheets. An upper stage of FIG. 4 schematically shows states of printed sheets. That is, page 1 is printed on the front of the first sheet, and page 2 is printed on the back thereof. Similarly, pages 3 and 4 are respectively printed on the front and the back of the second sheet, and pages 5 and 6 are respectively printed on the front and the back of the third sheet. The second and following stages of FIG. 4 show printing orders of the respective pages for the respective patterns.

The pattern P1 will be described. First, page 2 is printed on the back of the first sheet. Here, printing is performed from the back of each sheet, so that when the sheets subjected to double-sided printing are discharged and stocked, they can be stacked in order of page in the image forming apparatus 1. After the first sheet, the back side of which is printed, is conveyed to the inversion conveyance unit 83, the second sheet is conveyed, and page 4 is printed on the back of the second sheet. The back of the second sheet is printed before printing of the front of the first sheet is completed, because the image forming apparatus 1 can simultaneously convey two sheets.

Next, page 1 is printed on the front of the first sheet conveyed from the inversion conveyance unit 83. After the second sheet, the back side of which is printed, is conveyed to the inversion conveyance unit 83, the first sheet subjected to double-sided printing is stacked on the paper discharge section 76. Subsequently, the third sheet is conveyed and page 6 is printed on the back of the third sheet.

Next, page 3 is printed on the front of the second sheet conveyed from the inversion conveyance unit 83. After the third sheet, the back side of which is printed, is conveyed to the inversion conveyance unit 83, the second sheet subjected to double-sided printing is stacked on the paper discharge section 76. Then, the printed third sheet is conveyed from the inversion conveyance unit 83, and page 5 is printed on the front of the third sheet.

In the pattern P2, after double-sided printing is completed by alternately printing the first sheet and the second sheet by using the inversion conveyance unit 83, both sides of the third sheet are printed. In the pattern P3, after both sides of the first sheet are printed, the second sheet and the third sheet are alternately printed by using the inversion conveyance unit 83. In pattern P4, after both sides of the first sheet are printed, both sides of the second sheet are printed, and then, both sides of the third sheet are printed.

As stated above, in this embodiment, plural printing patterns different in printing order can be created by using the function to enable two-sheet simultaneous conveyance in double-sided printing. Incidentally, a description will be made later to an algorithm of listing printing order patterns when the number of pages to be printed is n and the image forming apparatus 1 can simultaneously convey m sheets.

At Act 03 of FIG. 3, with respect to all listed printing patterns, the number of times of switching between full color and black is calculated. When the full color is denoted by C and the black is denoted by K, the case of the pattern P1 is C→K→C→K→C→K and the number of times of switching is five. The case of the pattern P2 is C→K→C→C→K→K and the number of times of switching is three. The case of the pattern P3 is C→C→K→K→C→K and the number of times of switching is three. The case of the pattern P4 is C→C→K→C→K→K and the number of times of switching is three.

At Act 04, a printing pattern in which the calculated number of times of switching is smallest is selected. According to the result of Act 03, the numbers of times of switching in the patterns P2, P3 and P4 are smaller than that in the pattern P1. However, the numbers of times of switching in the patterns P2, P3 and P4 are the same. In that case, any pattern may be selected. In this case, the pattern P2 whose pattern number is smallest is selected.

Incidentally, when one pattern is selected from plural patterns having the same number of times of switching, a pattern having excellent sheet conveyance efficiency may be selected. For example, a required time from start of printing to end of printing is calculated for each of the patterns, and a pattern having the shortest required time may be selected.

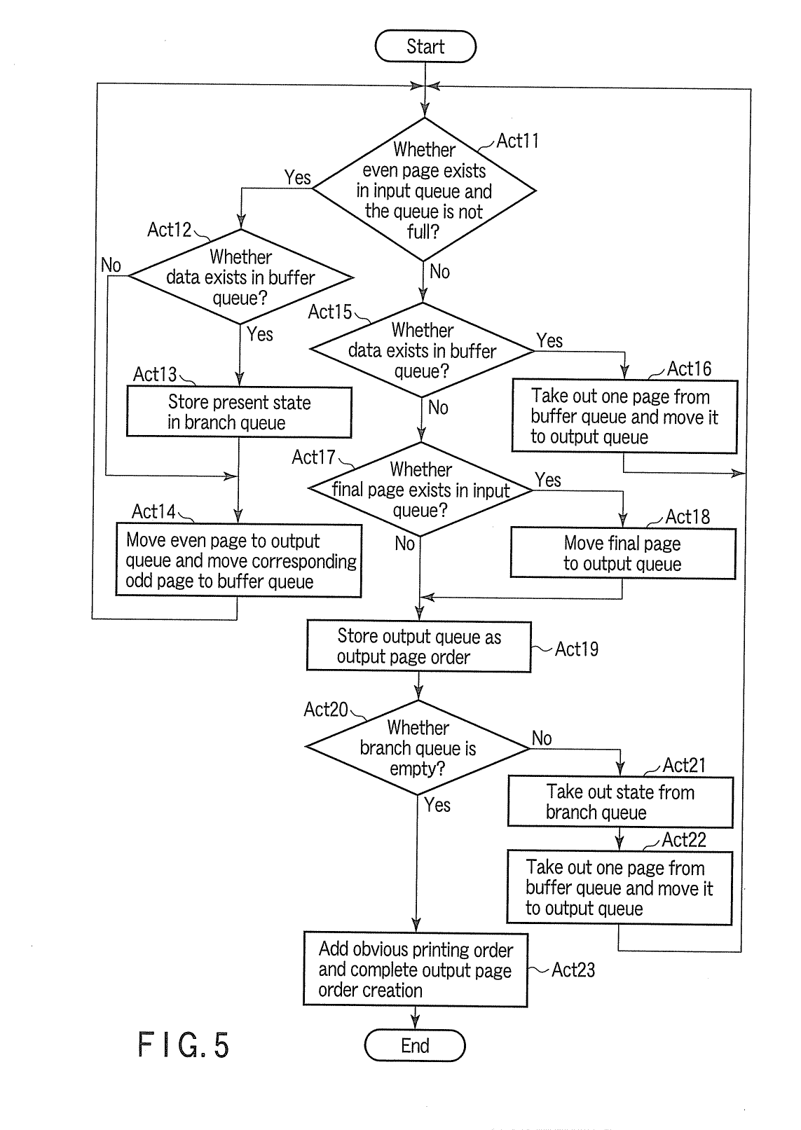

FIG. 5 is a flowchart showing a procedure of listing printing orders in which double-sided printing becomes possible. In this procedure, the printing order is listed using four queues (data files). The four queues are an input queue (IN Queue), a buffer queue (Q Queue), an output queue (OUT Queue) and a branch queue (BRANCH Queue).

The input queue (IN Queue) is an area corresponding to a file in which image data read by the scanner is stored. The buffer queue (Q Queue) is an area capable of storing data the number of which is equal to the number of sheets which can be held by the image forming apparatus 1. The output queue (OUT Queue) is an area corresponding to a file in which image data is stored in order of printing. The branch queue (BRANCH Queue) is an area in which a state during the printing order listing process is stored and a process is started from the state.

It is assumed that at the time of process start, data of pages 1 to 6 are stored in the IN Queue. The initial states of the OUT Queue, the Q Queue and the BRANCH Queue are empty. In this state, the process proceeds from the start of the flowchart shown in FIG. 5, and a loop is repeated plural times, so that a printing order is created in the OUT Queue. Then, when the process is ended, all printing orders are listed and stored in the OUT Queue.

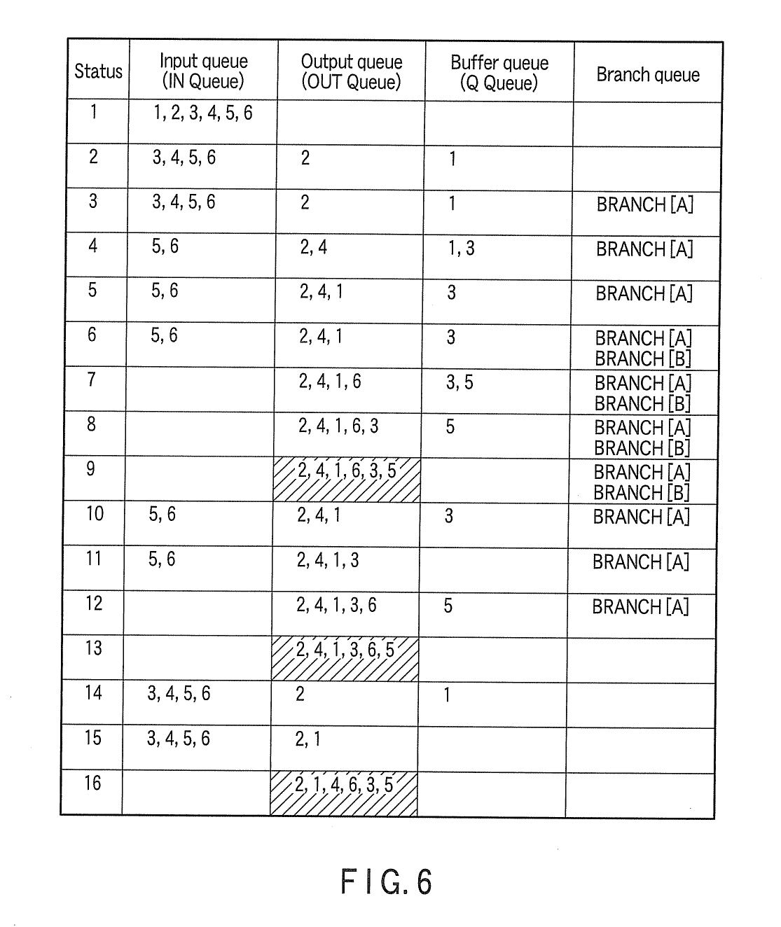

FIG. 6 is a view showing data (pages) stored in the respective queues when the procedure proceeds in accordance with the flow. The procedure of listing the printing orders in the case of 6-page double-sided printing will be described with reference to FIG. 5 and FIG. 6. Incidentally, the state of each queue is denoted by writing a page within a bracket after an abbreviation of the queue, such as IN[1,2], OUT[3] or Q[4,5]. The BRANCH is denoted by writing an identification sign within a bracket, such as BRANCH[A]. Incidentally, when there is no data, any queue is denoted by [0].

The initial state (status 1) is IN[1,2,3,4,5,6], OUT[0], Q[0], and BRANCH[0].

(Loop 1)

At Act 11, it is Checked Whether an Even Page exists in the IN Queue, and the IN Queue is not full. Since this result is YES, at Act 12, it is checked whether data exists in the Q Queue. Since this result is No, the process of Act 14 is executed.

At Act 14, the first even page in the IN Queue is moved to the OUT Queue, and an odd page corresponding to the same sheet is moved to the Q Queue. This result (status 2) is IN[3,4,5,6], OUT[2], Q[1] and BRANCH[0].

(Loop 2)

At Act 11, it is checked whether an even page exists in the IN Queue, and the IN Queue is not full. Since this result is YES, at ACT 12, it is checked whether data exists in the Q Queue. Since this result is Yes, the process of Act 13 is executed. At Act 13, the present state is stored in the BRANCH Queue. This result (status 3) is IN[3,4,5,6], OUT[2], Q[1] and BRANCH[A]=(IN[3,4,5,6], OUT[2], Q[1]). At Act 14, the first even page in the IN Queue is moved to the OUT Queue, and an odd page corresponding to the same sheet is moved to the Q Queue. This result (status 4) is IN[5,6], OUT[2,4], Q[1,3] and BRANCH[A].

(Loop 3)

At Act 11, it is checked whether an even page exists in the IN Queue and the IN Queue is not full. Here, the IN Queue is full of two data. Accordingly, this result is No. At Act 15, it is checked whether data exists in the Q Queue. Since this result is Yes, advance is made to Act 16.

At Act 16, one page is taken out from the Q Queue and is moved to the OUT Queue. This result (status 5) is IN[5,6], OUT[2,4,1], Q[3] and BRANCH [A].

(Loop 4)

Since the result is Yes at Act 11 and is Yes at Act 12, at Act 13, the present state is stored in the BRANCH Queue. This result (status 6) is IN[5,6], OUT[2,4,1], Q[3], BRANCH[A] and BRANCH[B]=(IN[5,6], OUT[2,4,1], Q[3]).

At Act 14, the first even page in the IN Queue is moved to the OUT Queue, and an odd page corresponding to the same sheet is moved to the Q Queue. This result (status 7) is IN[0], OUT[2,4,1,6], Q[3,5], BRANCH[A] and BRANCH[B].

(Loop 5)

At Act 11, it is checked whether an even page exists in the IN Queue and the IN Queue is not full. Here, even data does not exist in the IN Queue. Accordingly, the result is No. At Act 15, it is checked whether data exists in the Q Queue. Since this result is Yes, advance is made to Act 16.

At Act 16, one page is taken out from the Q Queue and is moved to the OUT Queue. This result (status 8) is IN[0], OUT[2,4,1,6,3], Q[5], BRANCH[A] and BRANCH[B].

(Loop 6)

Since the result is No at Act 11 and is Yes at Act 15, Act 16 is executed. This result (status 9) is IN[0], OUT[2,4,1,6,3,5], Q[0], BRANCH[A] and BRANCH[B].

(Loop 7)

Since the result is No at Act 11 and is No at Act 15, Act 17 is executed. At Act 17, it is checked whether the final page exists in the IN Queue. Since this result is No, Act 19 is executed. Incidentally, the case of Yes at Act 17 is the case where image data of an odd number of pages are printed.

At Act 19, the content of the OUT Queue is stored as an output page order. As a result, the printing order of 2→4→1→6→3→5 (pattern P1) is determined.

Subsequently, at Act 20, it is checked whether the BRANCH Queue is empty. Since this result is No, at Act 21, one state (BRANCH[B]) is taken out, and the state is set. This result (status 10) is IN[5,6], OUT[2,4,1], Q[3] and BRANCH[A].

At Act 22, one page is taken out from the Q Queue and is moved to the OUT Queue. This result (status 11) is IN[5,6], OUT[2,4,1,3], Q[0] and BRANCH[A].

(Loop 8)

Since the result is Yes at Act 11 and is No at Act 12, at Act 14, the first even page in the IN Queue is moved to the OUT Queue, and an odd page corresponding to the same sheet is moved to the Q Queue. The result (status 12) is IN[0], OUT[2,4,1,3,6], Q[5] and BRANCH[A].

(Loop 9)

At Act 11, it is checked whether an even page exists in the IN Queue and the IN Queue is not full. Here, even data does not exist in the IN Queue. Accordingly, this result is No. At Act 15, it is checked whether data exists in the Q Queue. Since this result is Yes, advance is made to Act 16.

At Act 16, one page is taken out from the Q Queue and is moved to the OUT Queue. This result (status 13) is IN[0], OUT[2,4,1,3,6,5], Q[0] and BRANCH[A].

(Loop 10)

Since the Result is No at Act 11, is No at Act 15 and is No at Act 17, Act 19 is executed. At Act 19, the content of the OUT Queue is stored as an output page order. As a result, the printing order of 2→4→1→3→6→5 (pattern P2) is determined.

Subsequently, at Act 20, it is checked whether the BRANCH Queue is empty. Since this result is No, at Act 21, one state (BRANCH[A]) is taken out, and the state is set. This result (status 14) is IN[3,4,5,6], OUT[2], Q[1] and BRANCH[0].

At Act 22, one page is taken out from the Q Queue and is moved to the OUT Queue. This result (status 15) is IN[3,4,5,6], OUT[2,1], Q[0] and BRANCH[0].

(Loop 11)

When the Process is Repeated Similarly hereinafter, the printing order of 2→1→4→6→3→5 (pattern P3) is obtained as (status 16). At Act 20, since the BRANCH Queue is empty, the result is Yes, and at Act 23, an obvious printing order of 2→1→4→3→6→5 (pattern P4), in which the front and back of each sheet are successively printed on a sheet-by-sheet basis, is added, and the output page order creation process is ended.

As a result of the above process, four output orders of [2,4,1,6,3,5], [2,4,1,3,6,5], [2,1,4,6,3,5] and [2,1,4,3,6,5] are determined.

In the above-described algorithm shown in FIG. 6, the page as the print object is moved between the respective queues in conformity with the movement of the sheet. Accordingly, it is conceivable that this algorithm simulates the print operation. The BRANCH Queue stores the state of the respective queues each time one sheet is selected as the object of double-sided printing in this algorithm. The stored state of the respective queues is used for creating a new printing order.

Incidentally, in the embodiment, the process example in which all pages are previously known is described. However, even if information to the final page is not known, when information of a specified number of pages is inputted, printing can be started. For example, in the foregoing case, at the time point when information of print data of six sheets is known, the printing pattern is calculated and printing can be started.

Besides, although the embodiment is applied to the double-sided printing apparatus capable of simultaneously conveying two sheets, the embodiment can also be applied to a double-sided printing apparatus capable of simultaneously conveying three or more sheets. In the algorithm shown in FIG. 5, the capacity of the Q Queue has only to be set correspondingly to the number of sheets which can be simultaneously conveyed.

Incidentally, when the printing order is created, in addition to the use of the foregoing algorithm, plural printing orders obtained based on the number of pages to be printed and the number of sheets which can be simultaneously conveyed by the image forming apparatus are written in a table in advance, and reference may be made to the table. However, even in that case, the printing orders recorded in the table are the result obtained by using the foregoing algorithm.

Incidentally, although the operation of the image forming apparatus of the embodiment is the switching operation between the full color mode and the black mode, the embodiment may be applied to a switching operation between a two-color mode in which printing is performed using two colors and a monocolor mode in which printing is performed using a single color. Accordingly, the operation of the image forming apparatus of the embodiment can be generally applied to a switching operation between a color mode in which printing is performed using two or more colors and a monocolor mode in which printing is performed using a single color.

The image forming apparatus of the embodiment as described above has remarkable effects as compared with the related art.

In the related art, a printing order of plural jobs different in process speed is changed to an order different from a reception order of the jobs. Since the printing order itself is interchanged, the plural jobs are mixed and are discharged to a storage tray, and there is an inconvenience that the user himself/herself must search for his/her own print pages.

In order to avoid this problem, according to another technique, it is proposed that a discharge position on a storage tray is offset for each job. However, in this system, when stapling or the like is specified, measures can not be taken.

In this embodiment, since jobs are not interchanged, a page is not divided, and the order is not interchanged. Besides, since the number of times of switching of the color mode can be made smaller than that of the related art, the exhaustion of the drum and the developing unit is reduced, and the printing performance can be improved.

Incidentally, the respective functions described in the embodiment may be configured using hardware, or may be realized by causing a computer to read programs describing the respective functions by using software. Besides, the respective functions may be configured by suitably selecting the software and the hardware.

Further, the respective functions can be realized by causing a computer to read a program stored in a not-shown recording medium. Here, a recording form of the recording medium in this embodiment may be any form as long as the recording medium can record the program and is readable by the computer.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image forming apparatus having a double-sided printing function and a function of simultaneously conveying a plurality of sheets, comprising:
an information acquisition section configured to acquire the number of pages of sheets to be printed and information indicating whether printing in a color mode is performed or printing in a monocolor mode is performed for each page;
a printing order creation section configured to create a plurality of sets of page printing orders, in which printed sheets are outputted in a job reception order, based on the acquired number of pages and the number of sheets which can be simultaneously conveyed;
a switching number calculation section configured to calculate the number of times of switching between the color mode and the monocolor mode for each of the plurality of created sets of page printing orders; and
a printing order selection section configured to select one set of page printing order having the smallest calculated number of times of switching.

2. The apparatus of claim 1, wherein
the printing order creation section creates the plurality of sets of page printing orders by combining a first printing method in which printing is performed on one surface of a first sheet and next, printing is performed on the other surface of the first sheet, and a second printing method in which printing is performed on one surface of a first sheet and next, printing is performed on one surface of a second sheet, and then, printing is performed on the other surface of the first sheet.

3. The apparatus of claim 2, wherein the printing order creation section creates the plurality of sets of page printing orders based on an algorithm using the acquired number of pages and the number of sheets which can be simultaneously conveyed.

4. The apparatus of claim 3, wherein the printing order creation section creates the plurality of sets of page printing orders by performing a simulation of a print operation by moving information indicating a page among an input area to store information indicating respective pages to be printed, a buffer area to store information indicating pages of the sheets, as an object of double-sided printing, the maximum number of which is the number of simultaneously conveyed sheets, and an output area to store information indicating pages in an order of printing.

5. The apparatus of claim 4, wherein the printing order creation section stores a state of information stored in the input area, the buffer area and the output area each time one sheet is selected as the object of double-sided printing during execution of the simulation, and creates a new page printing order by moving the information indicating the pages from the stored state in a sequence different from a previous one.

6. The apparatus of claim 2, wherein the printing order creation section creates the plurality of sets of page printing orders by searching a table corresponding to the acquired number of pages and the number of sheets which can be simultaneously conveyed.

7. The apparatus of claim 1, wherein when a plurality of sets of page printing orders have the smallest calculated number of times of switching, the printing order selection section selects one arbitrary set of page printing order in those sets.

8. The apparatus of claim 1, wherein when a plurality of sets of page printing orders have the smallest calculated number of times of switching, the printing order selection section selects one set of page printing order in which a required time from start of printing to end of printing is shortest in those sets.

9. The apparatus of claim 1, wherein
the color print mode is a full color print mode, and
the monocolor print mode is a black print mode.

10. An image forming method of an image forming apparatus having a double-sided printing function and a function of simultaneously conveying a plurality of sheets, comprising:
acquiring the number of pages of sheets to be printed and information indicating whether printing in a color mode is performed or printing in a monocolor mode is performed for each page;
creating a plurality of sets of page printing orders, in which printed sheets are outputted in a job reception order, based on the acquired number of pages and the number of sheets which can be simultaneously conveyed;
calculating the number of times of switching between the color mode and the monocolor mode for each of the plurality of created sets of page printing orders; and
selecting one set of page printing order having the smallest calculated number of times of switching.

11. The method of claim 10, wherein the creating of the printing order comprises:
creating the plurality of sets of page printing orders by combining a first printing method in which printing is performed on one surface of a first sheet and next, printing is performed on the other surface of the first sheet, and a second printing method in which printing is performed on one surface of a first sheet and next, printing is performed on one surface of a second sheet, and then, printing is performed on the other surface of the first sheet.

12. The method of claim 11, wherein the creating of the printing order comprises:
creating the plurality of sets of page printing orders based on an algorithm using the acquired number of pages and the number of sheets which can be simultaneously conveyed.

13. The method of claim 12, wherein the creating of the printing order comprises:
creating the plurality of sets of page printing orders by performing a simulation of a print operation by moving information indicating a page among an input area to store information indicating respective pages to be printed, a buffer area to store information indicating pages of the sheets, as an object of double-sided printing, the maximum number of which is the number of simultaneously conveyed sheets, and an output area to store information indicating pages in an order of printing.

14. The method of claim 13, wherein the creating of the printing order comprises:
storing a state of information stored in the input area, the buffer area and the output area each time one sheet is selected as the object of double-sided printing during execution of the simulation; and
creating a new page printing order by moving the information indicating the pages from the stored state in a sequence different from a previous one.

15. The method of claim 11, wherein the creating of the printing order comprises:
creating the plurality of sets of page printing orders by searching a table corresponding to the acquired number of pages and the number of sheets which can be simultaneously conveyed.

16. The method of claim 10, wherein the selecting of the printing order comprises:
selecting, when a plurality of sets of page printing orders have the smallest calculated number of times of switching, one arbitrary set of page printing order in those sets.

17. The method of claim 10, wherein the selecting of the printing order comprises:
selecting, when a plurality of sets of page printing orders have the smallest calculated number of times of switching, one set of page printing order in which a required time from start of printing to end of printing is shortest in those sets.

18. The method of claim 10, wherein
the color print mode is a full color print mode, and the monocolor print mode is a black print mode.

19. An image forming apparatus having a double-sided printing function and a function of simultaneously conveying a plurality of sheets, comprising:
information acquisition means for acquiring the number of pages of sheets to be printed and information indicating whether printing in a color mode is performed or printing in a monocolor mode is performed for each page;
printing order creation means for creating a plurality of sets of page printing orders, in which printed sheets are outputted in a job reception order, based on the acquired number of pages and the number of sheets which can be simultaneously conveyed;
switching number calculation means for calculating the number of times of switching between the color mode and the monocolor mode for each of the plurality of created sets of page printing orders; and
printing order selection means for selecting one set of page printing order having the smallest calculated number of times of switching.
